(19) United States
(12) Patent Application Publication
(10) Pub. No.: US 2003/0164767 A1
(43) Pub. Date: Sep. 4, 2003

(54) Burglar alarm

(76) Inventor: Sang J. Choi, Homewood, IL (US)

Correspondence Address: SANG J. CHOI, 2425 W. 183 RD ST., HOMEWOOD, IL, 60430, US

(21) Appl. No.: 10/086,823

(22) Filed: Mar. 4, 2002

(51) Int. Cl. G08B 13/14

(52) U.S. Cl. 340/568.1; 340/568.3

(57) ABSTRACT

An alarm system attached to an electronic or electrical device is triggered by unplugging or removing AC power cord. The circuit of said alarm system is monitoring the presence of AC voltage. If it finds the absence of the AC source, then said alarm is activated. Included in the alarm system is a timer circuit, which stops the alarm sounding after certain period of time that is adjustable. An LED is indicating that said alarm is armed. The alarm system is designed such a way that it consumes very little current during a quiescent state to save the battery usage. Said alarm system is battery powered for it's own circuit. The power supply circuit generates DC voltage for the purpose of checking AC voltage connection to the power line.

### FEDERALLY SPONSORED RESEARCH OR DEVELOPMENT

Not applicable.

### MICROFICHE APPENDIX

Not applicable.

### BACKGROUND OF THE INVENTION

The importance of the protection of electronic/electrical devices from being stolen are emphasized since many such a valuable devices are used in hospitals, schools, and laboratories. Various alarm apparatus systems are invented and produced to fulfil the necessity arisen from the experiences that those expensive devices have been lost. There are many different ways to activate an alarm system by using different type of sensors or radio communication devices. Sensors have their inherent lapse in adjusting their sensitivity. If a sensor is adjusted too sensitive, it may cause false alarm while if it is adjusted too loosely, it may miss a triggering of the alarm. One prior art is using a radio communication system to activate an alarm system by applying a transmitter and a receiver combination. This system accompanies with various operational flaws. With this system the sensitivity will change by the distance between transmitter and receiver, and by the orientation of the two devices. Some alarm systems use a motion detector as an alarming initiator. The installation of the detector itself requires a quite of work. As the solution of all the aforementioned shortcomings of an alarm device, the present invention utilizes the method of unplugging power cord for activating an alarm system as explained in the summary part and in the detailed description section.

### SUMMARY OF THE INVENTION

The present invention is regarding to a burglar alarm means which will be activated by unplugging the power cord connected to an alarm means and an electronic/electrical device in parallel. A comparator circuit is checking the state of the power cord connection constantly. When the cord is unplugged or broken, it will generate a right polarity of output to said alarm apparatus. The inverter circuit inverts the comparator output to the opposite polarity that is the negative going pulse and trigger the next stage, timer circuit. Timer circuit is responsible to control the time length how long the alarm will be turn on. The power amplifier amplifies the output current to provide enough power to drive the sound device. The novel feature of this invention is the way activating an alarm device which is securely fastened or attached to an electrical/electronic apparatus. If a person try to move an electronic device from one location to another location, one should unplug the power cord. This will also disconnect the AC power from the alarm device and activate it. This method is quite different from the most other features such as motion sensor, infrared sensor, or shock sensor. Those sensing devices are very critical to adjust the sensitivity. This invention's method to initiate an alarm condition is very straight forward, plugged or unplugged, no gray area. The sound device can be a speaker, buzzer, horn, chime, or any other noise generating apparatus. This invention will provide an alarm system which is economical to manufacture, easy to use and install, and versatile in it's function. The inverter stage can be eliminated by redesigning the comparator circuit with the output polarity of high level during quiescent state. But this will draw more quiescent current wasting power while it is inactive. A battery powered device can not afford wasting power while the system is not active. One simple additional transistor circuit will be well worth compensating the power loss during quiescent state of the system.

### BRIEF DESCRIPTION OF THE DRAWINGS

FIG. 1 is a detailed schematic of the present invention.

FIG. 2 is a block diagram of the present invention.

FIG. 3 is showing how a power cords are connected to an electronic/electrical device and to an alarm apparatus of this invention.

FIG. 4 is showing that said alarm device is mounted inside the housing (case) of said electronic device.

FIG. 5 is illustrating that said alarm circuit is included on the Printed Circuit Board of said electronic device.

### DETAILED DESCRIPTION OF THE PREFERRED EMBODIMENT

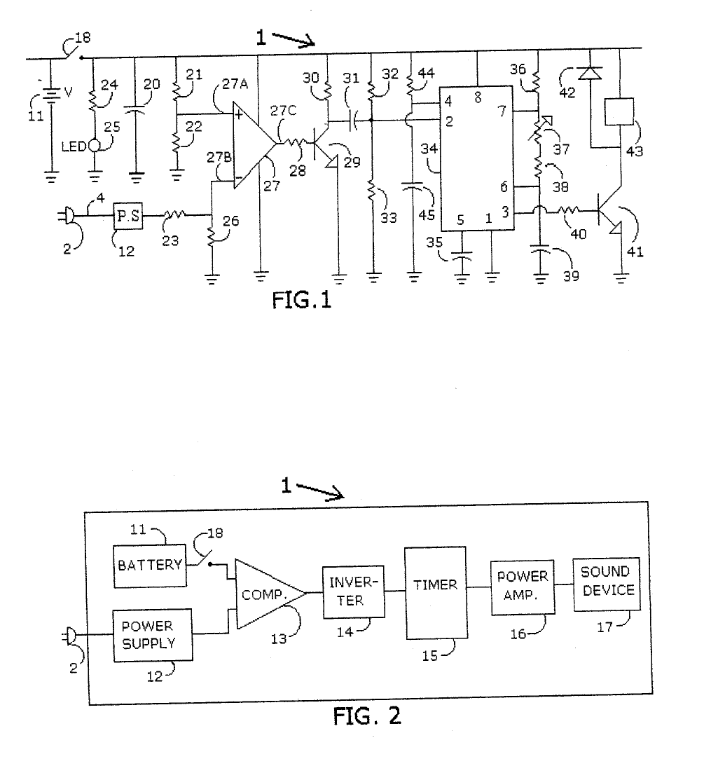

Referring to FIG. 1, it illustrates the schematic diagram showing in components level for the present invention of an alarm system designed to protect an electrical or an electronic apparatus from being burglarized. This circuit uses 2 power sources, one is a battery (11) which provides the necessary power for the operation of the whole alarm circuit. All components' value should be chosen such a way it saves power consumption during quiescent state. The other voltage source is obtained from AC source (2) through a power supply circuit (12). This voltage is just used at the comparator circuit to test whether the cord (4) is plugged or unplugged on an AC outlet. When switch (18) is closed, the battery voltage is connected to the alarm circuit and the LED (25) is lit. The resistor (24) is current limiting resistor to protect the LED (25). The main part of the comparator stage is an operational amplifier (27). The operational amplifier has 2 input terminals, (27A) and (27B). As the name implies, the comparator stage compares 2 input values, (27A) and (27B) and produces an output (27C) with a voltage either high or low level. If input at (27A) is higher than the input at (27B), the output (27C) is at high level. The output impedance of an operational amplifier (27C) is normally very low. That is why the output should be kept low voltage level while it is in quiescent state to save the power consumption. To meet this requirement (Low output), the input at (27B) should be higher than the input at (27A). To meet this condition: V (27B)>V(27A), the voltage divider circuit resistors (21) and (22) and resistors (23) and (26) are to be designed accordingly. During the non activated state of the alarm device, voltage at (27C) is low level which keeps the transistor (29) cut off, not allowing any current through it. Resistor (28) is a current limiting resistor for the base terminal of the transistor (29). (30) is a collector resistor for the inverter circuit. The coupling capacitor (31) couples a negative going pulse at the collector of the inverter to the trigger terminal of the timer chip (34). Without capacitor (31), if power connector (2) remains unconnected, timer chip is repeatedly triggered when the timer is timed out and activating the alarm again. With the capacitor in the place, the alarm is triggered just once for the period determined R.C. network for every disconnection. The coupled negative going pulse at pin #2 triggers the timer circuit. Once the timer circuit is triggered, it produces the positive pulses on the pin #3 of the timer chip. 3 resistors, (38), (37), and (36), and the capacitor (39) determine the width of the positive pulse. (37) is a potentiometer. The width of the output pulse can be adjusted by varying the potentiometer. The time period is determined by the following formula:

T=1.1×(R(36)+R(37)+R(38))C(39). For example, if C(39)=4.7 micro farad, R(38)=1 M ohms, R(37)=30 M ohms, and R(36)=10 k ohms, the time period can be adjusted in the range of approximately 5 seconds to 150 seconds (2.5 minutes), The C (35) is a filtering capacitor that eliminates any noise signal from appearing on the pin #5 of the chip. The noise signal may affect the timer by resetting it irregularly. Resistors, (32) and (33) are voltage divider circuit, which determine the DC voltage level on the pin #2. The voltage level should be kept higher than the one third of the battery voltage (11). Pin #4 of the timer chip (34) is reset terminal. Resistor (44) and capacitor (45) make sure the timer circuit is not activated during turning power on period. The transistor circuit (41) provides the amplification of the collector current, which drives a sound generating device (43). (40) is a current limiting resistor for the base circuit of the transistor (41). The diode (42) filters the spike voltage developed on the collector of the transistor at the instant the transistor cuts off, preventing the transistor from being damaged. Capacitor (20) filters any AC component riding on the DC voltage of the batteries. Sound generating device (43) can be buzzer, horn, siren, chime, or any other noise making device. FIG. 2 is a block diagram version of this invention. The comparator (13) is comparing 2 inputs, one from the battery D.C. voltage (11) and the other from the power supply (12). Under the condition that the power cord is plugged (connected to the power outlet), the following will happen: the associated voltage divider circuits are so designed that the output of the comparator is at low level. The output of the inverter stage (14) is at high level. The timer is in inactive state and alarm is not activated. When the power cord (2) is unplugged (disconnected from the power outlet), the following will happen: the output of the comparator is at high level and the inverter output (14) is at low level creating a negative going pulse which triggers the timer circuit (15) producing a positive pulse on the output terminal of pin #3. The pulse width is determined by the R.C. circuit. During this period of pulse time, the alarm (17) is activated. For the power switch (18), key switch, toggle switch, slide switch, remote control with transmitter and receiver, push button, or any other type of switch can be applied. A responsible person may disable said alarm feature by turning off the switch (18) under a given situation deemed necessary.

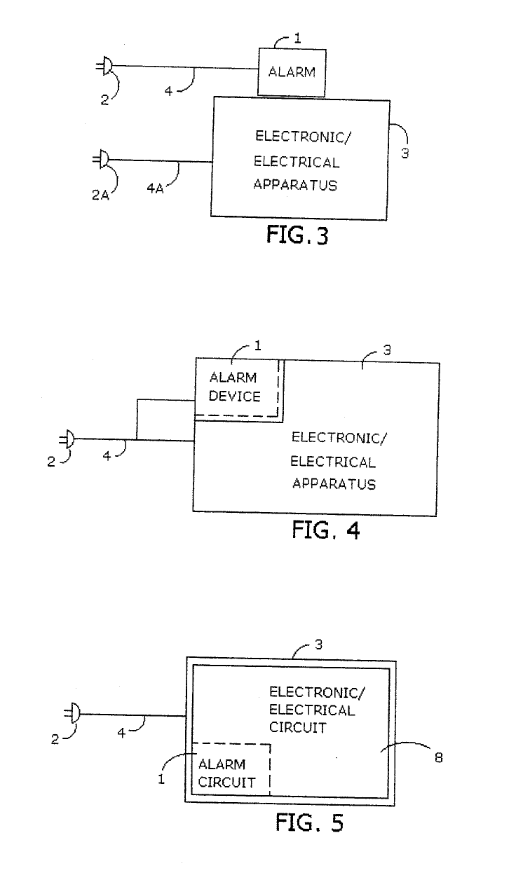

FIG. 3 shows an alarm device (1) of this invention mounted on an electronic/electrical device (3). Epoxy glue or some other type of double face adhesive strips can be used for attaching securely the alarm device to an electronic apparatus, or special case (housing) can be made with appropriate mounting bracket on it. FIG. 3 also shows the way power cords are connected. To move said electronic device (3), the cord (4) connected to said alarm device should be unplugged or broken because said alarm (1) is securely attached to the electronic device (3). This will activate the alarm.

FIG. 4 is showing that said alarm (1) is mounted inside the housing of the electronic device (3). A split power cord (4) is directly connected to any available power outlet. Said alarm device may be mounted on an inconspicuous place inside or outside of said electrical apparatus (3).

FIG. 5 illustrates that said alarm circuit (1) is assembled on a portion of the printed circuit board (8) of said electronic device (3) during manufacturing process.

What I claim is:

1. A burglar alarm apparatus attached to an electronic or electrical device, activated by unplugging a power cord connected to said alarm means comprising: a battery for providing power to the alarm circuit, power switch means for enabling or disabling said alarm, power supply means for convertingt AC to DC which is used to check whether the power cord is connected to the power source, comparator for comparing two inputs and producing one output with the appropriate voltage level either high level or low level depending upon the power cord states unplugged or plugged, inverter means for inverting the comparator output polarity to the opposite polarity at the collector of the inverter, timer circuit for generating time delay, power amplifier for amplifying the output current high enough to drive the sound device, sound device for generating audible sound, power cord for connecting said alarm to the power source means, case for housing the apparatus, and mounting means for attaching said alarm apparatus to the electronic or electrical device by double face adhesive strip, or by a fastener.

2. A burglar alarm apparatus according to claim 1 wherein the power supply means is: receiving an AC voltage from an AC outlet through a power cord, converting said AC voltage to DC voltage, applying said DC voltage to a input of the comparator while the power cord of the apparatus is plugged, and applying zero volt to the comparator while the cord is unplugged.

3. A Burglar alarm apparatus according to claim 1 wherein said comparator means (a) receives 2 DC voltages, 1 from said power supply and the other from the battery voltage, (b) produces, when the power cord is plugged, an output voltage level which keeps said alarm inactive, and (c) produces, when the power cord is unplugged, an output voltage level which activates said alarm.

4. A burglar alarm apparatus according to claim 1 wherein said timer means (a) comprises 555 timer chip and associated circuit, (b) produces a pulse output with the period adjustable by a potentiometer.

5. A burglar alarm apparatus according to claim 1 wherein said inverter (a) inverts the comparator output to the opposite polarity at the output, with the cord unplugged this output is negative going and triggers the timer circuits and activates the alarm, (b) stays cut off during quiescent state which saves the battery power.

6. A burglar alarm apparatus according to claim 1 wherein said case for housing the apparatus is to make the alarm as a stand alone device.

7. A method of activating an alarm apparatus, which is securely attached to an electronic or electrical device, by unplugging the power cord connected to said alarm apparatus caused by moving said electronic or electrical device.

8. A method of embedding an alarm means as part of an electrical or electronic device, said alarm means is activated when the power cord of said device is disconnected from a power outlet.

9. A method of embedding an alarm means according to claim 8 wherein said power cord connects AC voltage from an AC outlet to a power supply circuit for a DC voltage which is used by the both circuits of said alarm means and said electronic or electrical device.
